(19) United States
(12) Patent Application Publication
(10) Pub. No.: US 2017/0068123 A1
(43) Pub. Date: Mar. 9, 2017

(54) LIQUID CRYSTAL DISPLAY PANEL AND DEVICE

(71) Applicant: SHENZHEN CHINA STAR OPTOELECTRONICS TECHNOLOGY CO., LTD., GUANGDONG (CN)

(72) Inventor: Feng ZHAO, Guangdong (CN)

(21) Appl. No.: 14/890,599

(22) PCT Filed: Sep. 11, 2015
(86) PCT No.: PCT/CN2015/089437

§ 371 Date: Nov. 12, 2015

(30) Foreign Application Priority Data
Sep. 7, 2015 (CN) 201510562779.0

(51) Int. Cl. G02F 1/1339; G02F 1/1362; G02F 1/1335

(52) U.S. Cl. CPC G02F 1/13394; G02F 1/1339; G02F 1/133514; G02F 1/136286; G02F 2001/13396; G02F 2001/13398

(57) ABSTRACT

A liquid crystal display (LCD) panel and a LCD device are provided. A distance between a color film substrate and an array substrate in a safe area is reduced by disposing a photoresist layer within the safe area, so that support columns can support the array substrate in the safe area after being formed to a cell, and the thickness stability of the cell and the effect of the displayed images can be increased.

### FIELD OF THE INVENTION

The present invention relates to a technical field of displays, and in particular to a liquid crystal display (LCD) panel and a LCD device.

### BACKGROUND OF THE INVENTION

Recently, a wide safe distance is configured between a sealant area and a display area of the liquid crystal display panel to form a safe area for preventing the glue frame from polluting the alignment film layer and the liquid crystal. The liquid crystal is filled into the interspace between the upper and lower substrates in the safe area and the display area.

For supporting the interspace between the upper and lower substrates, a plurality of support columns (post spacer, PS) are disposed on the color film substrate in the safe area and the display area of the liquid crystal display panel. Refer to FIG. 1, the liquid crystal display panel has a display area 101, a safe area 102, a sealant area 103, a plurality of support columns 105 located in the display area 101, and plurality of support columns 106 located in the safe area 102.

However, the photoresist layer of the color film substrate (upper substrate) is only formed in the display area, and does not extend to the safe area. Therefore, the photoresist layer does not exist on a bottom of the support column in the safe area. A distance between the upper and lower substrates in the safe area is greater than a distance between the upper and lower substrates in the display area after being formed to a cell of the liquid crystal display panel, and the support columns in the safe area cannot support the substrate, and the support columns are unable to be used. Thus, the thickness stability of the cell is not high enough, so that the effect of displayed images is poor.

Refer to FIG. 2 which is a cross-sectional view of a traditional liquid crystal display panel from FIG. 1. The liquid crystal display panel has a color film substrate, an array substrate 202, and a sealant 203. The color film substrate has a base substrate 2011, a black array layer 2011, a photoresist layer 2012 disposed in the display area 101, and an alignment film layer 2013 between the black array layer 2011 and the photoresist layer 2012.

After being formed a cell of the liquid crystal display panel, the photoresist layer 2012 is disposed below the alignment film layer 2013 in the display area 101, so a distance d1 between the alignment film layer 2013 and the array substrate 202 in the display area 101 is greater than a distance d2 between the alignment film layer 2013 and the array substrate 202 in the safe area 102, and greater than a distance d3 between the black array layer 2011 and the array substrate 202 in the safe area 102.

Therefore, after being formed a cell of the liquid crystal display panel, the support columns 106 in the safe area 102 cannot support the substrate 202, and the support columns unable to be used. Thus, the thickness stability of the cell is not high enough, so that the effect of displayed images is poor.

Therefore, a liquid crystal display (LCD) panel and a LCD device need to be developed which solve the problems existing in the conventional art as described above.

### SUMMARY OF THE INVENTION

An object of the present invention is to provide a liquid crystal display (LCD) panel and a LCD device, which solves the technical problems, such as the thickness stability of the cell of the liquid crystal display panel is not high enough, and the effect of displaying images is poor.

To achieve the above object, the technical of the present invention is described as follows:

The present invention provides a liquid crystal display (LCD) panel which includes a display area for displaying images, a sealant area for sealing the LCD panel, and a safe area for isolating the display area from the sealant area and disposed between the display area and the sealant area;

wherein the LCD panel comprises:

an array substrate;

a color film substrate; and

a liquid crystal filled between the array substrate and the color film substrate;

wherein the array substrate has a plurality of data lines, a plurality of scan lines and a plurality of pixel units;

the data lines are configured to transmit data signals;

the scan lines are configured to transmit scan signals; and

the pixel units are formed by interlacing the data lines and the scan lines in the display area, and configured to display the images according the data signals and the scan signals;

wherein the color film substrate has:

a first photoresist layer disposed within the display area;

a second photoresist layer disposed within the safe area, wherein the first photoresist layer and the second photoresist layer are formed integrally;

a plurality of first support columns disposed on the first photoresist layer; and

a plurality of second support columns disposed on the second photoresist layer, wherein a volume of the second support column is greater than that of the first support column;

wherein the second photoresist layer is configured to reduce a distance between color film substrate and the array substrate in the safe area, so that the second support columns support the array substrate.

In one embodiment of the present invention, a cross-section of the second support column is strip-shaped.

In one embodiment of the present invention, a distribution density of the second support columns in the safe area is greater than that of the first support columns in the display area.

In one embodiment of the present invention, an area of the second photoresist layer is equal to that of the safe area.

In one embodiment of the present invention, the first support columns and the second support columns are formed simultaneously.

To achieve the above object, the present invention provides another liquid crystal display (LCD) panel which includes a display area for displaying images, a sealant area for sealing the LCD panel, and a safe area for isolating the display area from the sealant area and disposed between the display area and the sealant area;

wherein the LCD panel comprises:

an array substrate;

a color film substrate; and

a liquid crystal filled between the array substrate and the color film substrate;

wherein the array substrate has a plurality of data lines, a plurality of scan lines and a plurality of pixel units;

the data lines are configured to transmit data signals;

the scan lines are configured to transmit scan signals; and

the pixel units are formed by interlacing the data lines and the scan lines in the display area and configured to display the images according the data signals and the scan signals;

wherein the color film substrate has:

a first photoresist layer disposed within the display area;

a second photoresist layer disposed within the safe area;

a plurality of first support columns disposed on the first photoresist layer; and

a plurality of second support columns disposed on the second photoresist layer;

wherein the second photoresist layer is configured to reduce a distance between color film substrate and the array substrate in the safe area, so that the second support columns support the array substrate.

In one embodiment of the present invention, a volume of the second support column is greater than that of the first support column.

In one embodiment of the present invention, a cross-section of the second support column is strip-shaped.

In one embodiment of the present invention, a distribution density of the second support columns in the safe area is greater than that of the first support columns in the display area.

In one embodiment of the present invention, the first photoresist layer and the second photoresist layer are formed integrally.

In one embodiment of the present invention, an area of the second photoresist layer is equal to that of the safe area.

In one embodiment of the present invention, the first support columns and the second support columns are formed simultaneously.

To achieve the above object, the present invention further provides a liquid crystal display (LCD) device which comprises:

an LCD panel; and

a backlight module disposed below the LCD panel for providing a light source to the LCD panel;

wherein the LCD panel includes a display area for displaying images, a sealant area for sealing the LCD panel, and a safe area for isolating the display area from the sealant area and disposed between the display area and the sealant area;

wherein the LCD panel comprises:

an array substrate;

a color film substrate; and

a liquid crystal filled between the array substrate and the color film substrate;

wherein the array substrate has a plurality of data lines, a plurality of scan lines and a plurality of pixel units;

the data lines are configured to transmit data signals;

the scan lines are configured to transmit scan signals; and

the pixel units are formed by interlacing the data lines and the scan lines in the display area, and configured to display the images according the data signals and the scan signals;

wherein the color film substrate comprises:

a first photoresist layer disposed within the display area;

a second photoresist layer disposed within the safe area;

a plurality of first support columns disposed on the first photoresist layer; and

a plurality of second support columns disposed on the second photoresist layer;

wherein the second support columns are disposed on the second photoresist layer. The second photoresist layer is configured to reduce a distance between color film substrate and the array substrate in the safe area, so that the second support columns support the array substrate.

In one embodiment of the present invention, a volume of the second support column is greater than that of the first support column.

In one embodiment of the present invention, a distribution density of the second support columns in the safe area is greater than that of the first support columns in the display area.

In one embodiment of the present invention, a cross-section of the second support column is strip-shaped.

In one embodiment of the present invention, the first photoresist layer and the second photoresist layer are formed integrally.

In one embodiment of the present invention, the first support columns and the second support columns are formed simultaneously.

In one embodiment of the present invention, an area of the second photoresist layer is equal to that of the safe area.

The embodiment of the present invention provides a liquid crystal display (LCD) panel and a LCD device. A distance between color film substrate and the array substrate in the safe area is reduced by disposing the photoresist layer within the safe area, so that the support columns can support the array substrate in the safe area after being formed to a cell, and the thickness stability of the cell and the effect of displaying images can be increased.

### DESCRIPTION OF THE DRAWINGS

FIG. 1 is a schematic view of a traditional liquid crystal display panel;

FIG. 2 is a cross-sectional view of a traditional liquid crystal display panel;

FIG. 3 is a schematic view of a liquid crystal display panel according to an embodiment of the present invention; and

FIG. 4 is a cross-sectional view of a liquid crystal display panel according to an embodiment of the present invention.

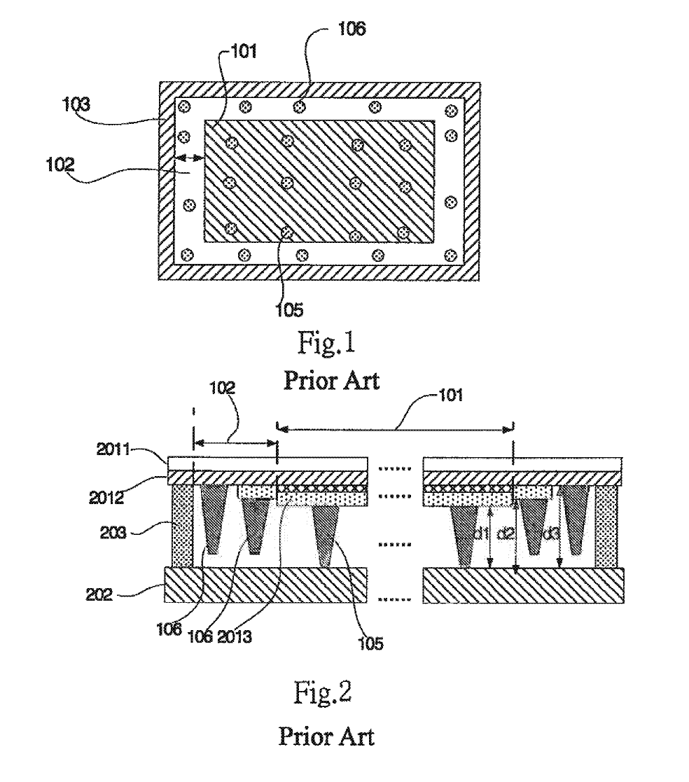

### DETAILED DESCRIPTION OF THE PREFERRED EMBODIMENTS

The structure and the technical means adopted by the present invention to achieve the above and other objects can be best understood by referring to the following detailed description of the preferred embodiments and the accompanying drawings. Furthermore, directional terms described by the present invention, such as upper, lower, front, back, left, right, inner, outer, side, longitudinal/vertical, transverse/horizontal, etc., are only directions by referring to the accompanying drawings, and thus the used directional terms are used to describe and understand the present invention, but the present invention is not limited thereto.

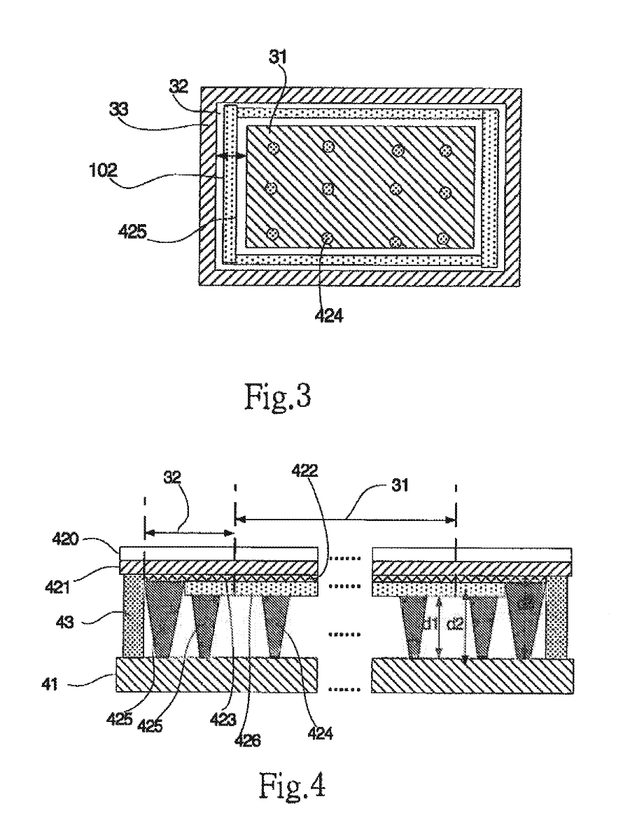

Refer to FIGS. 3 and 4; an embodiment of the present invention provides a liquid crystal display (LCD) panel. The liquid crystal display panel includes a display area 31 for displaying images, a sealant area 33 for sealing the LCD panel, and a safe area 32 for isolating the display area 31 from the sealant area 33, wherein the safe area 32 is disposed between the display area 31 and the sealant area 33.

The liquid crystal display panel of the embodiment comprises:

an array substrate 41;

a color film substrate;

a liquid crystal filled between the array substrate 41 and the color film substrate; and

a sealant 43 located between the array substrate 41 and the color film substrate for sealing the liquid crystal between the array substrate 41 and the color film substrate, and for fixing the array substrate 41 and the color film substrate.

The array substrate 41 has a plurality of data lines, a plurality of scan lines and a plurality of pixel units (not shown);

the data lines are configured to transmit data signals;

the scan lines are configured to transmit scan signals; and

the pixel units are formed by interlacing the data lines and the scan lines in the display area 31, and the pixel units are configured to display the images according the data signals and the scan signals.

The color film substrate has:

a base substrate 420;

a black array layer 421 disposed on the base substrate 420 for shielding a light;

a first photoresist layer 422 disposed within the display area 31 for displaying color images;

a second photoresist layer 423 disposed within the safe area 32;

a plurality of first support columns 424 disposed on the first photoresist layer 422; and

a plurality of second support columns 425 disposed on the second photoresist layer 423. As shown in the Figures, the second support columns 425 can be disposed on the second photoresist layer 423 directly, or disposed on the second photoresist layer 423 through an alignment film layer 426.

Preferably, the first photoresist layer 422 and the second photoresist layer 423 are formed integrally in the embodiment of the present invention for simplifying the machining process and reducing the manufacturing cost.

Preferably, the first support columns 424 and the second support columns 425 are formed simultaneously in the embodiment of the present invention for simplifying the machining process and reducing the manufacturing cost.

The alignment film layer 426 is disposed between the first photoresist layer 422 and the second photoresist layer 423.

A distance between color film substrate and the array substrate 41 in the safe area 32 is reduced by disposing the photoresist layer 423, so that the second support columns 425 can support the array substrate 41. The distances d2, d3 between color film substrate and the array substrate 41 in FIG. 4 is less than the distances d2, d3 between color film substrate and the array substrate. Preferably, an area of the second photoresist layer 423 is equal to that of the safe area 32 in the embodiment, so that all of the second support columns 425 in the safe area 32 can support the array substrate 41. The use of which can also be based on actual needs, an area difference between the second photoresist layer 423 and the safe area 32 is set in a preset range.

The liquid crystal display panel in FIG. 4 compared with the liquid crystal display panel in FIG. 2, the distance between color film substrate and the array substrate 41 for disposing the second support columns 425 in the safe area is reduced after disposing the second photoresist layer 423 in the safe area 32. The second support columns 425 can support the array substrate 41 after being formed a cell of the liquid crystal display panel, so that the thickness stability of the cell and the effect of displaying images can be increased.

Considering a shape of the post spacer (PS) is small and a distribution density of the post spacer is low in the safe area 32 (equal to the shape and the distribution density of the post spacer in the display area 31). Therefore, an interspace volume between two substrates in the safe area 32 is large, and more liquid crystal needs to be filled in the cell to maintain the thickness of the cell, so that the liquid crystal would be wasted.

Preferably, a volume of the second support column 425 of the embodiment is greater than that of the first support column 424. The volume of the second support column 425 is increased, so that the interspace volume between the array substrate 41 and the color film substrate in the safe area 32 is reduced. The safe area 32 is just filled few liquid crystal, and the thickness of the cell can maintain, and reducing the liquid crystal consumption and the cost.

Preferably, a cross-section of the second support column 425 is strip-shaped in the embodiment of the present invention for saving the liquid crystal and the cost. In other words, the second support column 425 is an elongated block, or an elongated block with a large area, specifically. The shape of the second support column 425 in the embodiment is configured to increase the area, and support the substrate.

Furthermore, for reducing the liquid crystal from the interspace volume between the array substrate 41 and the color film substrate in the safe area 32, the distribution density of the second support column 425 of the embodiment is increased. Preferably, a distribution density of the second support columns 425 in the safe area 32 is greater than that of the first support columns 424 in the display area 31.

The shape and the distribution density can be set up by the design of the liquid crystal panel of which can also be based on actual needs. In FIG. 3, the second support columns 425 are almost connected with each other in the safe area by increasing the distribution and the volume to fill the volume between the array substrate 41 and the color film substrate in the safe area 32 for saving the liquid crystal and the cost.

### Embodiment 2

An embodiment of the present invention provides a liquid crystal display (LCD) device, which comprises:

an LCD panel; and

a backlight module disposed below the LCD panel for providing a light source to the LCD panel.

Refer to FIGS. 3 and 4; an embodiment of the present invention provides a liquid crystal display panel. The liquid crystal display panel includes a display area 31 for displaying images, a sealant area 33 for sealing the LCD panel, and a safe area 32 for isolating the display area 31 from the sealant area 33, wherein the safe area 32 is disposed between the display area 31 and the sealant area 33.

The liquid crystal display panel of the embodiment comprises:

an array substrate 41;

a color film substrate;

a liquid crystal filled between the array substrate 41 and the color film substrate; and

a sealant 43 is located between the array substrate 41 and the color film substrate for sealing the liquid crystal between the array substrate 41 and the color film substrate, and for fixing the array substrate 41 and the color film substrate.

The array substrate 41 has a plurality of data lines, a plurality of scan lines and a plurality of pixel units (not shown);

the data lines are configured to transmit data signals;

the scan lines are configured to transmit scan signals; and

the pixel units are formed by interlacing the data lines and the scan lines in the display area 31, and the pixel units are configured to display the images according the data signals and the scan signals.

The color film substrate has:

a first photoresist layer 422 disposed within the display area;

a second photoresist layer 423 disposed within the safe area;

a plurality of first support columns 424 disposed on the first photoresist layer 422; and

a plurality of second support columns 425 disposed on the second photoresist layer 423;

wherein a distance between color film substrate and the array substrate 41 in the safe area 32 is reduced by disposing the photoresist layer 423, so that the second support columns 425 can support the array substrate 41.

Preferably, for reducing the interspace volume between the array substrate 41 and the color film substrate in the safe area 32 and saving the liquid crystal and the cost, a volume of the second support column 425 of the embodiment is greater than that of the first support column 424.

Preferably, the distribution density of the second support columns 425 in the safe area 32 is greater than that of the first support columns 424 in the display area 31 for reducing the liquid crystal consumption and the cost.

The embodiment of the present invention provides a liquid crystal display (LCD) panel and a LCD device. A distance between color film substrate and the array substrate in the safe area is reduced by disposing the photoresist layer within the safe area, so that the support columns can support the array substrate in the safe area after being formed to a cell, and the thickness stability of the cell and the effect of displaying images can be increased.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A liquid crystal display (LCD) panel, including a display area for displaying images, a sealant area for sealing the LCD panel, and a safe area for isolating the display area from the sealant area and disposed between the display area and the sealant area, the LCD panel comprising:
an array substrate;
a color film substrate; and
a liquid crystal filled between the array substrate and the color film substrate;
wherein the array substrate has a plurality of data lines, a plurality of scan lines, and a plurality of pixel units;
the data lines being configured to transmit data signals;
the scan lines being configured to transmit scan signals; and
the pixel units formed by interlacing the data lines and the scan lines in the display area, and being configured to display the images according the data signals and the scan signals; and
wherein the color film substrate comprises:
a first photoresist layer disposed within the display area;
a second photoresist layer disposed within the safe area, the first photoresist layer and the second photoresist layer being formed integrally;
a plurality of first support columns disposed on the first photoresist layer; and
a plurality of second support columns disposed on the second photoresist layer, wherein a volume of the second support column is greater than that of the first support column; and
wherein the second photoresist layer is configured to reduce a distance between color film substrate and the array substrate in the safe area, so that the second support columns support the array substrate.

2. LCD panel according to claim 1, wherein a cross-section of the second support column is strip-shaped.

3. The LCD panel according to claim 1, wherein a distribution density of the second support columns in the safe area is greater than that of the first support columns in the display area.

4. The LCD panel according to claim 2, wherein a distribution density of the second support columns in the safe area is greater than that of the first support columns in the display area.

5. The LCD panel according to claim 1, wherein an area of the second photoresist layer is equal to that of the safe area.

6. The LCD panel according to claim 1, wherein the first support columns and the second support columns are formed simultaneously.

7. A liquid crystal display (LCD) panel, including a display area for displaying images, a sealant area for sealing the LCD panel, and a safe area for isolating the display area from the sealant area and disposed between the display area and the sealant area, the LCD panel comprising:
an array substrate;
a color film substrate; and
a liquid crystal filled between the array substrate and the color film substrate;
wherein the array substrate has a plurality of data lines, a plurality of scan lines and a plurality of pixel units;
the data lines being configured to transmit data signals;
the scan lines being configured to transmit scan signals; and
the pixel units formed by interlacing the data lines and the scan lines in the display area, and being configured to display the images according the data signals and the scan signals; and
wherein the color film substrate comprises:
a first photoresist layer disposed within the display area;
a second photoresist layer disposed within the safe area;
a plurality of first support columns disposed on the first photoresist layer; and
a plurality of second support columns disposed on the second photoresist layer; and
wherein the second photoresist layer is configured to reduce a distance between color film substrate and the array substrate in the safe area, so that the second support columns support the array substrate.

8. The LCD panel according to claim 7, wherein a volume of the second support column is greater than that of the first support column.

9. The LCD panel according to claim 8, wherein a cross-section of the second support column is strip-shaped.

10. The LCD panel according to claim 8, wherein a distribution density of the second support columns in the safe area is greater than that of the first support columns in the display area.

11. The LCD panel according to claim 7, wherein the first photoresist layer and the second photoresist layer are formed integrally.

12. The LCD panel according to claim 7, wherein an area of the second photoresist layer is equal to that of the safe area.

13. The LCD panel according to claim 7, wherein the first support columns and the second support columns are formed simultaneously.

14. A liquid crystal display (LCD) device, comprising:
an LCD panel; and
a backlight module disposed below the LCD panel for providing a light source to the LCD panel;
wherein the LCD panel includes a display area for displaying images, a sealant area for sealing the LCD panel, and a safe area for isolating the display area from the sealant area and disposed between the display area and the sealant area, the LCD panel comprising:
an array substrate;
a color film substrate; and
a liquid crystal filled between the array substrate and the color film substrate;
wherein the array substrate has a plurality of data lines, a plurality of scan lines and a plurality of pixel units;
the data lines being configured to transmit data signals;
the scan lines being configured to transmit scan signals; and
the pixel units formed by interlacing the data lines and the scan lines in the display area, and being configured to display the images according the data signals and the scan signals; and
wherein the color film substrate comprises:
a first photoresist layer disposed within the display area;
a second photoresist layer disposed within the safe area;
a plurality of first support columns disposed on the first photoresist layer; and
a plurality of second support columns disposed on the second photoresist layer; and
wherein the second photoresist layer is configured to reduce a distance between color film substrate and the array substrate in the safe area, so that the second support columns support the array substrate.

15. The LCD panel according to claim 14, wherein a volume of the second support column is greater than that of the first support column.

16. The LCD panel according to claim 14, wherein a distribution density of the second support columns in the safe area is greater than that of the first support columns in the display area.

17. The LCD panel according to claim 15, wherein a cross-section of the second support column is strip-shaped.

18. The LCD panel according to claim 14, wherein the first photoresist layer and the second photoresist layer are formed integrally.

19. The LCD panel according to claim 14, wherein the first support columns and the second support columns are formed simultaneously.

20. The LCD panel according to claim 14, wherein an area of the second photoresist layer is equal to that of the safe area.
